(19) United States
(12) Patent Application Publication
(10) Pub. No.: US 2015/0118666 A1
(43) Pub. Date: Apr. 30, 2015

(54) Toilet Training Doll for Children

(71) Applicant: Vanessa Rokjer, Ballston Spa, NY (US)

(72) Inventor: Vanessa Rokjer, Ballston Spa, NY (US)

(21) Appl. No.: 14/516,648

(22) Filed: Oct. 17, 2014

Related U.S. Application Data
(60) Provisional application No. 61/895,663, filed on Oct. 25, 2013.

(51) Int. Cl. G09B 5/04

(52) U.S. Cl. CPC G09B 5/04
USPC 434/236

(57) ABSTRACT

Disclosed is a toilet training aid for children. The device comprises a doll having a microphone, a sound recognition processing module, a memory, and a speaker imbedded therein. The sound recognition processing module is adapted to detect a clapping sound or a flushing sound. When either of the clapping sound or the flushing sound is detected through the microphone, a pre-recorded message recording is played through the speaker. The pre-recorded message recording verbally encourages the child and rewards the child for a successful completion of a toilet training experience. In one embodiment, the doll may resemble a princess, and in another embodiment, the doll may resemble a pirate. The doll further includes a clip that may be used to mount the doll onto a toilet tank or on a doll stand.

### CROSS REFERENCE TO RELATED APPLICATION

This application claims the benefit of U.S. Provisional Application No. 61/895,663 filed on Oct. 25, 2013. The above identified patent application is herein incorporated by reference in its entirety to provide continuity of disclosure.

### BACKGROUND OF THE INVENTION

1. Field of the Invention

The present invention relates to a toilet training aid for children. More specifically, the present invention pertains to an improved toilet training doll that encourages children who are being toilet trained. The doll is adapted to recognize the sound of clapping or a toilet flush and provides an audible encouragement. The doll comprises a hook that can be used to mount the doll to a support structure. In this way, the doll can be conveniently used in a bathroom during toilet training.

Most parents anticipate toilet training as a milestone in their child's development. Toilet training, however, is a long and a difficult process that can become frustrating and overwhelming for both the child and the parents. Thus, toilet training requires the child and parents to devote time, patience, and enforce positive encouragement.

Additionally, toilet training requires parents to provide the child with proper equipment to facilitate use of the toilet. For instance, a potty chair or an adaptor seat that attaches to a regular toilet seat can help children feel more comfortable on the toilet. Other devices comprise training aids that provide entertainment while the child is toilet training. Conventional training aids such as these, however, are not interactive and static. Additionally, toilet training gears are initially unfamiliar and generally do not appeal to children. Therefore, children are not motivated to use conventional training aids. Thus, an interactive training aid that appeals to children who are being toilet trained is desired.

The present invention relates to a toilet training aid for children. The present training aid is in a form of a doll, wherein the doll may resemble a princess or a pirate, depending upon embodiment. The doll comprises imbedded electrical components therein. In an exemplary embodiment, the electrical components include a microphone, a speaker, a memory, and a sound recognition processing module. The sound recognition processing module is adapted to detect the sound of clapping or flushing of a toilet through the microphone. When a clapping sound or a flushing sound is detected, the sound recognition processing module actuates the speaker to play a pre-recorded message that is stored in the memory. The pre-recorded message is preferably of a positive encouragement. It is contemplated that the pre-recorded message associated with the princess embodiment can be articulated by a female voice, and the pre-recorded message associated with the pirate embodiment can be articulated by a male voice. The doll further comprises a hook that can be used to mount the doll to the toilet tank or to a doll stand. Thus, the doll can be securely placed near the toilet while a child is toilet training.

The primary advantage of the present invention is not only its capability to provide an instant audible feedback upon successful use of the toilet, but also its outward appearance that appeals to children. Thus, the present invention motivates children to use the toilet. The present invention can be utilized until the child successfully completes toilet training, or as needed to continue monitoring the performance of the child's toilet training and to foster a good habit.

2. Description of the Prior Art

Devices have been disclosed in the prior art that claim toilet training aids in form of dolls. These include devices that have been patented and published in patent application publications. These devices generally disclose dolls that ingest a liquid and simulates urination. These devices, however, do not provide an audible feedback upon detecting sound of clapping and water flushing. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Published Patent Application Number 2004/0175688 to Smith discloses a toilet training doll comprising a doll with an interior volume adapted to hold a water bottle therein. When the water bottle is inserted in the doll, the valve of the water bottle is in fluid connection with an output port. Thus, when the doll is squeezed, the water from the water bottle can exit through the output port. Similarly, U.S. Pat. No. 5,509,808 to Bell and U.S. Pat. No. 5,890,907 to Minasian disclose toy toilet training systems that comprise a doll that receives a fluid through a mouth opening and that can discharge the fluid from an outlet to simulate urination. The toy toilet training systems further comprises a toy toilet to receive the discharged fluid. The foregoing devices, however, differ from the present invention in that the present invention is provides an audible feed back to the child when the child uses the toilet. The foregoing devices do not disclose electrical components necessary to perform this function.

U.S. Pat. No. 6,417,773 to Vlahos discloses a sound-actuated system for encouraging good personal hygiene in toilet facilities. The system comprises a microphone and a speaker that are in communication with a microcontroller. The microphone detects sound of running water to generate an audible output, which comprises a pre-recorded message that encourages the child. While the system of Vlahos discloses a sound-actuated system, Vlahos does not disclose dolls having such sound-actuated system imbedded therein. The present invention discloses dolls having an audio input means, an audio output means, and a sound detecting means. The present invention is advantageous in that the dolls appeal to children who are being toilet trained. Thus, the present invention provides an effective means to toilet train young children.

Finally, U.S. Pat. No. 5,363,516 to Butts discloses a toilet training aide comprising a receptacle for receiving urine therein. The bottom wall of the receptacle comprises thermally actuated latent image element whereby urine received within the receptacle actuates the element, causing the latent image to appear and be seen by the child. In this way, the device of Butts encourages the child to use the toilet. Unlike the present invention, however, the Butts does not disclose a doll that can play a pre-recorded sound.

The devices disclosed in the prior art have several known drawbacks. None of the devices in the prior art disclose a doll that is adapted to detect a clapping sound or a water flushing sound, whereby the doll can play a pre-recorded sound upon detecting such types of sounds. The present invention overcomes these limitations by disclosing a doll with imbedded electrical components, including a microphone, a speaker, a memory, and a sound recognition processing module for detecting sounds of clapping and water flushing. Additionally, the present doll resembles a princess or a pirate, depending upon embodiment. In this way, the present invention appeals to young children who are learning to use the toilet.

It is therefore submitted that the present invention is substantially divergent in design elements from the prior art, and consequently it is clear that there is a need in the art for an improvement to toilet training aids. In this regard, the instant invention substantially fulfills these needs.

### SUMMARY OF THE INVENTION

In view of the foregoing disadvantages inherent in the known types of toilet training aids now present in the prior art, the present invention provides a new and improved toilet training doll for children wherein the same can be utilized for rewarding children for successfully completing toilet training.

It is therefore an object of the invention to provide a new and improved toilet training doll for children that has all of the advantages of the prior art and none of the disadvantages.

Another object of the present invention is to provide a new and improved toilet training doll for children having a microphone, a speaker, a memory containing pre-recorded message, and a sound recognition processing module for detecting a clapping sound and a flushing sound.

Yet another object of the present invention is to provide a new and improved toilet training doll for children that provides an audible form of encouragement.

Yet another object of the present invention is to provide a new and improved toilet training doll for children wherein the doll resembles a princess.

Still yet another object of the present invention is to provide a new and improved toilet training doll for children wherein the doll resembles a pirate.

Still yet another object of the present invention is to provide a new and improved toilet training doll for children wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a front perspective view of a first embodiment of the present invention.

FIG. 2 shows a rear perspective view of a first embodiment of the present invention.

FIG. 3 shows a front perspective view of a second embodiment of the present invention.

FIG. 4 shows a rear perspective view of a second embodiment of the present invention.

FIG. 5 shows a schematic diagram of the internal components of an exemplary embodiment of the present invention.

### DETAILED DESCRIPTION OF THE INVENTION

References are made herein to the attached drawings. Like reference numerals are used throughout the drawings to depict like or similar elements of the toilet training doll for children. For the purposes of presenting a brief and clear description of the present invention, the preferred embodiment will be discussed as used to reward children for successfully completing toilet training. The figures are intended for representative purposes only and should not be considered to be limiting in any respect.

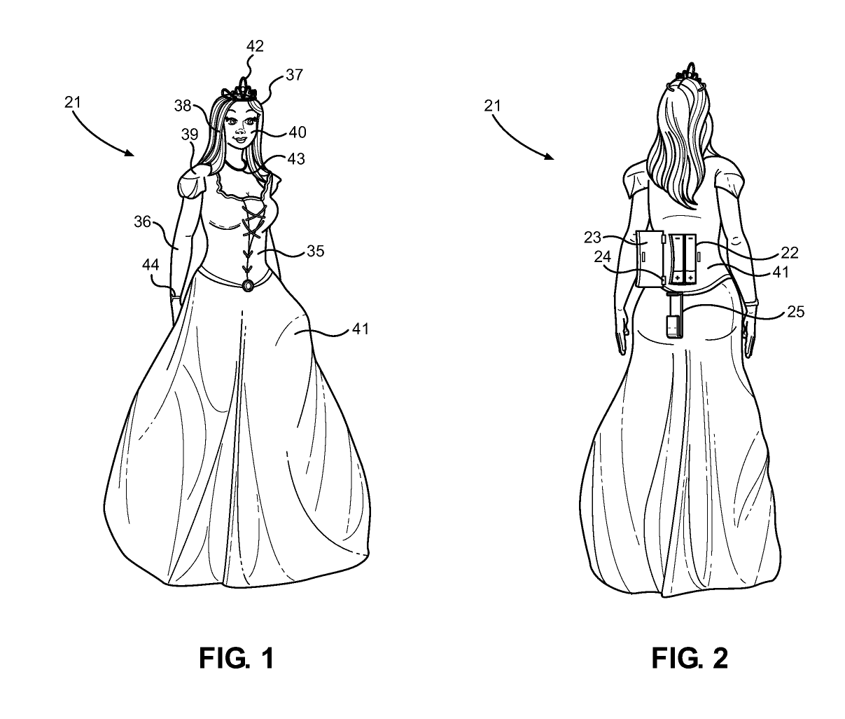

Referring now to FIGS. 1 and 2, there are shown front and rear perspective views of the first embodiment of the present invention. The present invention comprises a doll 21. In a first exemplary embodiment, the doll 21 resembles a princess. The doll 21 has a doll torso 35 having a pair of arms 36 and a head 37 rotatably attached thereto. The head 37 comprises a quantity of artificial hair 38 that fall down to the shoulders 39 of the torso 35, and a face 40 printed thereon with durable ink. The face 40 comprises eyebrows, eyes, lips, and cheeks. It is contemplated that in some embodiments, the face 40 may comprise a layer of protective coating on the exterior there of so that the eyebrows, eyes, lips, and cheeks are prevented from degradation.

The arms 36 are rotatably attached to the doll torso 35 so that the arms 36 can rotate. While not seen in FIG. 1, it is contemplated that the doll torso 35 further includes a pair of legs. The legs may be rotatably attached to the doll torso 35 so that the legs can move, thereby allowing the doll to walk. In some embodiments, the legs may bend at the knees so that the doll 21 can be manipulated into a seated position. The doll torso 35 is preferably composed of a molded plastic or other suitable material.

The doll 21 further comprises clothing, such as a floor length dress 41 supported upon the doll torso 35 as illustrated in FIGS. 1 and 2. Additionally, the doll 21 may comprise a tiara 42 supported on the head 37, a necklace 43 worn around the neck, a bracelet 44 worn around the wrist, and dress shoes. The doll 21 can be mounted to an edge of a toilet tank or to a doll stand via a clip 25 that is disposed on the back of the doll 21. The clip 25 is substantially J-shaped when viewed from the side. The clip 25 may be composed of metal, plastic, or other suitable material. The clip 25 is preferably permanently affixed to the back of the doll 21 via fasteners, such as a screw, or via strong adhesives so that the clip 25 does not become misplaced or lost.

The torso 35 of the doll 21 comprises a defined interior volume with internal electrical components therein. The electrical components are powered via batteries. As such, the doll 21 comprises a battery compartment 22 that is accessible via a door 23 that is attached to the back of the doll 21 via hinges 24. In the illustrated embodiment, the door 23 is a made to look like a part of the dress 41 so that it is camouflaged when it is closed and does not detract from the appearance of the doll 21. Additionally, the door 23 is accessible to the user from the exterior of the dress 41 so that the user does not have to disrobe the doll 21 to access the battery compartment 22.

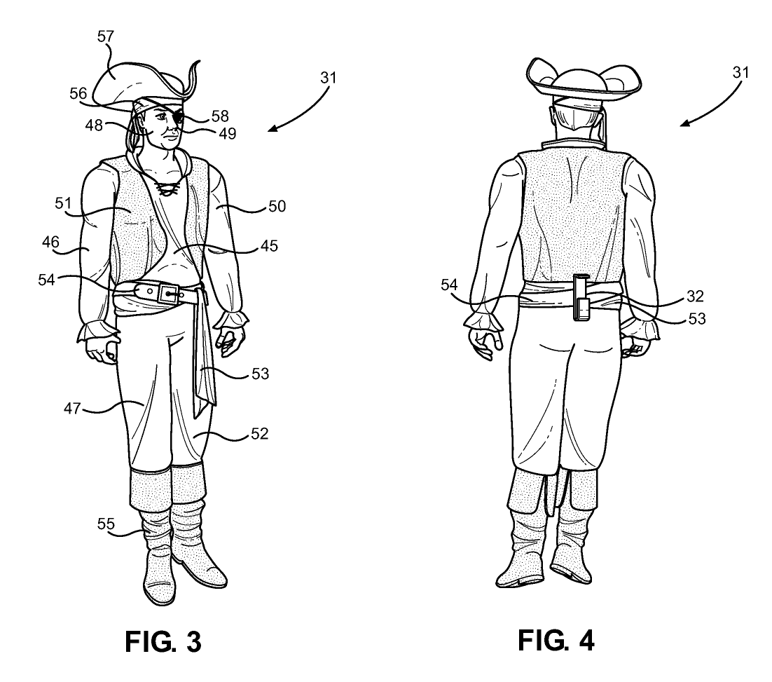

Referring now to FIGS. 3 and 4, there are shown views of the second embodiment of the present invention. The second embodiment of the present invention comprises a male pirate doll 31. Similar to the previous embodiment, the doll 31 comprises a doll torso 45 with rotatably attached arms 46, legs 47, and a head 48. In this way, the arms 46, the legs 47, and the head 48 can turn or rotate so that the doll 31 can be manipulated into various poses or stances. The head 48 comprises a printed face 49, including eyebrows, eyes, lips, and facial hair. The doll 31 further comprises a pirate outfit, which includes a long sleeved shirt 50, a vest 51, a pair of pants 52, a sash 53, and a belt 54. The doll 31 may further comprise pirate accessories such as boots 55, a head scarf 56, a pirate hat 57, and an eye patch 58. The doll 31 further includes a clip 32 that is disposed at the back near the sash 53 and the belt 54, as shown in FIG. 4.

The doll torso 45 of the illustrated embodiment comprises a hollow interior for holding internal components therein. The internal components are connected to a power source, such as batteries. The batteries are stored in the battery compartment that is disposed on the back of the torso 45, wherein the battery compartment is accessible via a door that may be secured thereto via a hinge or a snap fit. In the illustrated embodiment, the door to the battery compartment is concealed under the long sleeved shirt 50 that is worn over the torso 45.

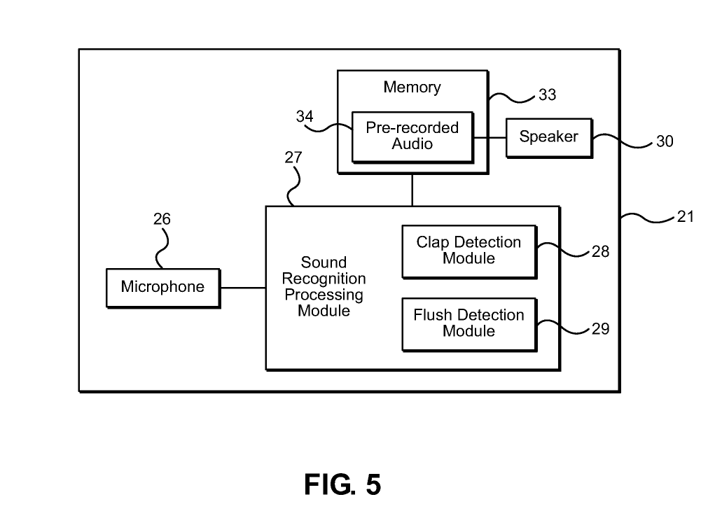

Referring now to FIG. 5, there is shown a schematic diagram of the internal components of an exemplary embodiment of the present invention. The internal components described herein are disposed in the hollow interior of the torso portion of the doll 21. The internal components comprise a microphone 26, a sound recognition processing module 27, a memory 33, and a speaker 30. It is contemplated that the internal components of the present invention are internally powered via a power source such as batteries.

The microphone 26 is adapted to receive audio input, and relay the received audio to the sound recognition processing module 27. The sound recognition processing module 27 comprises a clap detection module 28 and a flush detection module 29. The clap detection module 28 is adapted to detect the sound of hands clapping, while the flush detection module 29 can detect the sound of running water or toilet flushing. If the clap detection module 28 detects a clapping sound or the flush detection module 29 detects a sound of toilet flushing, the sound recognition processing module 27 actuates the speaker 30 to play a pre-recorded message or audio 34 that is stored in the memory 33.

The pre-recorded message or audio 34 is preferably of a positive encouragement, such as a cheer, a compliment, or other types of verbal feedback. The pre-recorded message or audio 34 may comprise recordings of different messages or audio 34. Additionally, the pre-recorded message or audio 34 can be selected and played randomly so that the child hears a different message each time after successfully using the toilet.

The pre-recorded message or audio 34 may be customized to correlate to the personality of the dolls. For instance, the first embodiment, as illustrated in FIG. 1, may be adapted to play messages that incorporate princess-like sayings. The second embodiment as illustrated in FIG. 3 may be adapted to play messages that incorporate pirate phrases and terms. It is contemplated that the pre-recorded message associated with the first embodiment can be articulated by a female voice, and the pre-recorded message associated with the second embodiment can be articulated by a male voice. Furthermore, the female voice may be whimsical and good-natured to emulate a personality of a fictional princess. Conversely, the male voice may comprise an accent to emulate a personality of a fictional pirate. In this way, the voice or the audible output of the doll is correlated with its outward appearance.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A toilet training doll for children, comprising:
a doll having a hollow doll torso with a pair of arms, a pair of legs, and a head rotatably attached thereto;
said torso supporting clothing thereon;
said torso having electrical components comprising a microphone, a memory storing a pre-recorded audio, a speaker, and a sound recognition processing module imbedded therein;
said microphone adapted to relay a sound to said sound recognition processing module;
wherein said sound recognition processing module actuates said speaker to play said pre-recorded audio upon detecting a sound of hands clapping or a sound of a toilet flush;
a power source connected to said electrical components;

2) The toilet training doll of claim 1, wherein said sound recognition processing module comprises a clap detection module and a flush detection module;
said clap detection module adapted to recognize said sound of hands clapping;
said flush detection module adapted to recognize said sound of a toilet flush.

3) The toilet training doll of claim 1, further comprising a hook affixed to a back of said torso.

4) The toilet training doll of claim 1, further comprising wherein said power source is a battery.

5) The toilet training doll of claim 4, wherein said torso further comprises a battery compartment and a door.

6) The toilet training doll of claim 1, wherein said pre-recorded audio comprises a compliment or a cheer.

7) The toilet training doll of claim 1, wherein said doll resembles a princess.

8) The toilet training doll of claim 7, wherein said pre-recorded audio comprises a message that can be articulated by a female voice.

9) The toilet training doll of claim 7, wherein said clothing comprises a dress.

10) The toilet training doll of claim 1, wherein said doll resembles a pirate.

11) The toilet training doll of claim 10, wherein said pre-recorded audio comprises a message that can be articulated by a male voice.

12) The toilet training doll of claim 10, wherein said clothing comprises a long sleeved shirt, a vest, a pair of pants, a sash, a belt, and a pair of boots.
